(19) United States
(12) Patent Application Publication
(10) Pub. No.: US 2011/0064287 A1
(43) Pub. Date: Mar. 17, 2011

(54) CHARACTERIZING A TEXTURE OF AN IMAGE

(76) Inventor: Alexandru Bogdan, New York, NY (US)

(21) Appl. No.: 12/876,549

(22) Filed: Sep. 7, 2010

Related U.S. Application Data
(60) Provisional application No. 61/242,204, filed on Sep. 14, 2009.

(51) Int. Cl. G06K 9/00

(52) U.S. Cl. 382/128

(57) ABSTRACT

Among other things, a texture of an image is characterized by deriving entropy-based lacunarity parameters from density distributions generated from the image based on a wavelet analysis. In some examples, lacunarity descriptors are extracted from textured regions using wavelet maxima. The distributions of the local wavelet maxima density in a sliding window over the region of interest are compared using different methods in order to generate lacunarity parameters.

This application is entitled to the priority of U.S. provisional application Ser. 61/242,204, filed on Sep. 14, 2009, and is related to U.S. application Ser. Nos. 11/956,918, filed Dec. 14, 2007, and PCT/US08/86576, filed Dec. 12, 2008. The contents of these applications are incorporated here by reference in their entirety.

### BACKGROUND

This description relates to characterizing a texture of an image.

Melanoma is the deadliest form of skin cancer and the number of reported cases is rising steeply every year. In state of the art diagnosis, the dermatologist uses a dermoscope which can be characterized as a handheld microscope. Recently image capture capability and digital processing systems have been added to the field of dermoscopy as described, for example, in Ashfaq A. Marghoob MD, Ralph P. Brown MD, and Alfred W Kopf MD MS, editors. Atlas of Dermoscopy. The Encyclopedia of Visual Medicine. Taylor & Francis, 2005. The biomedical image processing field is moving from just visualization to automatic parameter estimation and machine learning based automatic diagnosis systems such as MELA Sciences' MelaFind® (D. Gutkowicz-Krusin, M. Elbaum, M. Greenebaum, A. Jacobs, and A. Bogdan. System and methods for the multispectral imaging and characterization of skin tissue, 2001. U.S. Pat. No. 6,081,612), and Siemens' LungCAD (R. Bharat Rao, Jinbo Bi, Glenn Fung, Marcos Salganicoff, Nancy Obuchowski, and David Naidich. LungCAD: a clinically approved, machine learning system for lung cancer detection. In KDD (Knowledge Discovery and Data Mining) '07: Proceedings of the 13th ACM SIGKDD international conference on Knowledge discovery and data mining, pages 1033-1037, New York, N.Y., USA, 2007. ACM.) These systems use various texture parameter estimation methods applied to medical images obtained with a variety of detectors.

Fractal analysis has become a standard technique in signal processing. In practice, this often means the estimation of a scaling (fractal) or spatial distribution (lacunarity) law exponent. Fractal and multifractal analysis was inspired by the Fractal Geometry, introduced by Mandelbrot (see B. Mandelbrot, The Fractal Geometry of Nature, San Francisco, Calif.: Freeman, 1983), as a mathematical tool to deal with signals that did not fit the conventional framework. It can describe natural phenomena such as the irregular shape of a mountain, stock market data, or the appearance of a cloud. Sample applications of fractal analysis include cancer detection (see A. J. Einstein, H.-S. Wu, and J. Gil, “Self-affinity and lacunarity of chromatin texture in benign and malignant breast epithelial cell nuclei,” Phys. Rev. Lett., vol. 80, no. 2, pp. 397-400, January 1998), assessing osteoporosis (see A. Zaia, R. Eleonori, P. Maponi, R. Rossi, and R. Murri, “Mr imaging and osteoporosis: Fractallacunarity analysis of trabecular bone,” Information Technology in Biomedicine, IEEE Transactions on, vol. 10, no. 3, pp. 484-489, July 2006), remote sensing (see W. Sun, G. Xu, and S. Liang, “Fractal analysis of remotely sensed images: A review of methods and applications,” International Journal of Remote Sensing, vol. 27, no. 22, November 2006), and others too numerous to be mentioned here.

The wavelet transform is often described as a mathematical microscope. Wavelet maxima extract only the relevant information from the continuous wavelet representation.

The space-scale localization property makes wavelets and wavelet maxima a natural tool for the estimation of fractal parameters. See S. Mallat, A Wavelet Tour of Signal Processing, 2nd ed. Academic Press, 1999. The wavelet maxima representation (WMR) has been used for the estimation of fractal self-similarity dimension (see S. Mallat, A Wavelet Tour of Signal Processing, 2nd ed. Academic Press, 1999), and of the lacunarity of one dimensional signals. See J. Laksari, H. Aubert, D. Jaggard, and J. Tourneret, “Lacunarity of fractal superlattices: a remote estimation using wavelets,” IEEE Transactions on Antennas and Propagation, vol. 53, no. 4, pp. 1358-1363, April 2005).

Image textures for melanoma have been shown to possess valuable information useful for the discrimination of melanoma from similar looking atypical pigmented skin lesions. See P. Wighton, T. K. Lee, D. McLean, H. Lui, and M. Stella, “Existence and perception of textural information predictive of atypical nevi: preliminary insights,” in Medical Imaging 2008: Image Perception, Observer Performance, and Technology Assessment, ser. Proceedings of the SPIE, vol. 6917. SPIE, April 2008. The use of fractal texture descriptors for melanoma detection has been attempted before, e.g. see A. G. Manousaki, A. G. Manios, E. I. Tsompanaki, and A. D. Tosca, “Use of color texture in determining the nature of melanocytic skin lesions a qualitative and quantitative approach,” Computers in biology and medicine, vol. 36, no. 4, April 2006.

### SUMMARY

In general, in an aspect, a texture of an image is characterized by deriving entropy-based lacunarity parameters from density distributions generated from the image based on a wavelet analysis.

Implementations may include one or more of the following features. The entropy-based lacunarity parameters for the density distributions are derived from information theory entropy of wavelet maxima density distributions. One or more texture features for the image can be generated from the density distributions using the entropy-based lacunarity parameters. The image includes a multispectral image. The image includes an image of a biological tissue. The wavelet analysis is based on a wavelet maxima representation of a gray scale image. The image includes an analysis region having a skin lesion. The entropy-based lacunarity parameters are estimated at various scales. The entropy-based lacunarity parameters are estimated in local regions of the image The density distributions are derived at least in part based on a gliding box method. The gliding box method uses a window of fixed characterizing size R. The window includes a circular window. Wavelet maxima in the window are counted to generate a distribution of the counts indexed by a wavelet level L.

These and other aspects and features, and combinations of them, may be phrased as methods, systems, apparatus, program products, means for performing functions, databases, and in other ways.

Other advantages and features will become apparent from the following description and the claims.

### DESCRIPTION

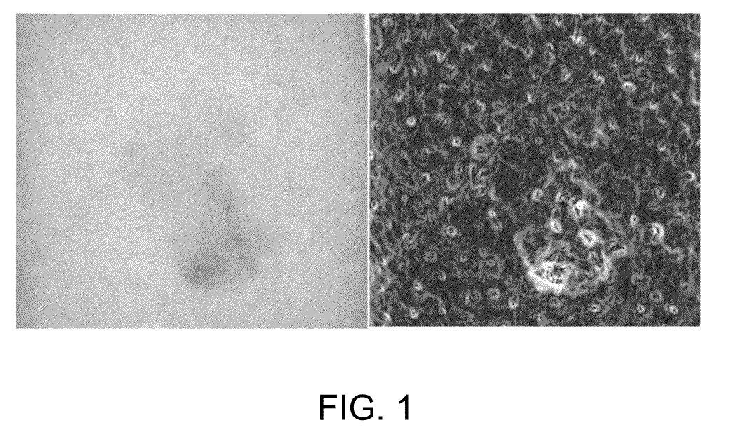

FIG. 1 shows intensity (left side) and the continuous wavelet transform (CWT), level 3, modulus Mfₐ(x,y) (right side), images for the infrared spectral band image of a malignant lesion. Bright pixels in the right side image correspond to points of large variation.

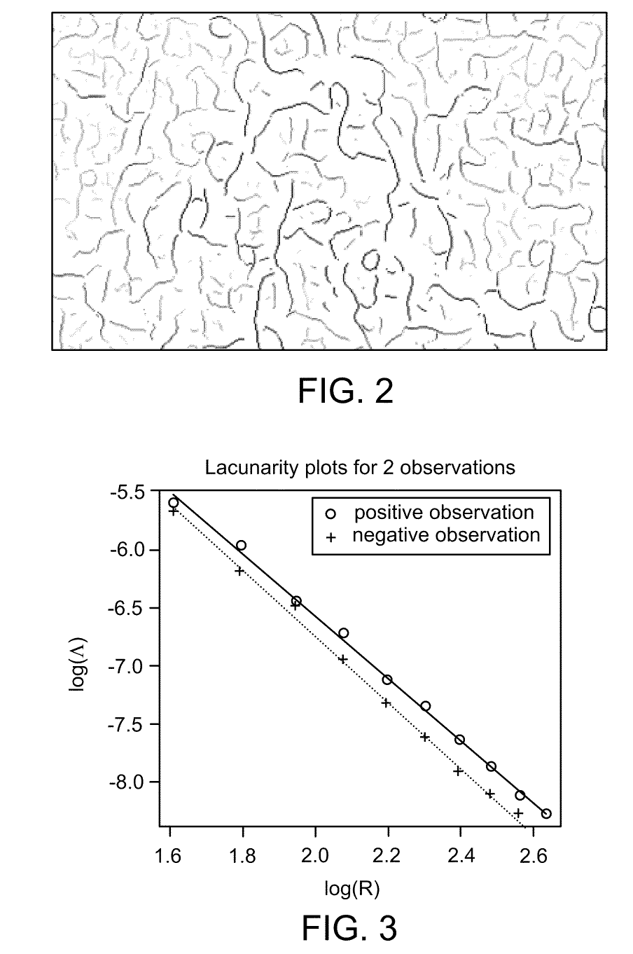

FIG. 2 shows a zoom on the WMR, level 3, positions for the infrared image (of FIG. 1).

FIG. 3 shows lacunarity plots and linear approximations for two observations, one positive and one negative. Window radius is from 5 to 14 pixels

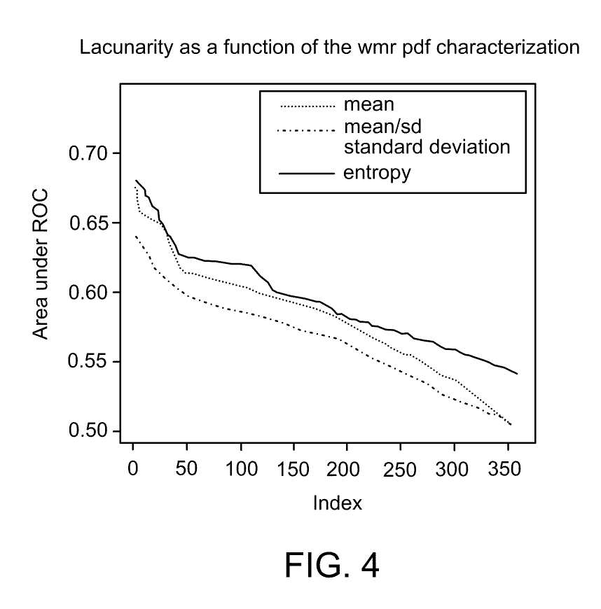

FIG. 4 shows performance of the lacunarity features grouped by the way the wavelet maxima distribution inside the gliding box is characterized. The figure of merit is area under ROC.

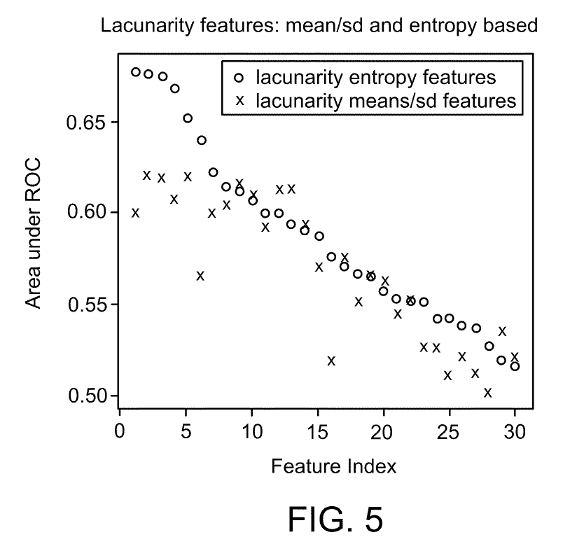

FIG. 5 shows performance of lacunarity features based on entropy and mean/standard deviation (LCN_I).

A class of texture parameters (features or descriptors in machine learning jargon) was inspired by the Fractal Geometry introduced by Mandelbrot. See B. Mandelbrot, The Fractal Geometry of Nature, San Francisco, Calif.: Freeman, 1983. In the fractal framework, a signal is described by its scaling properties (self-similarities) and spatial homogeneity or translation invariance (lacunarity). The continuous wavelet transform (CWT), often described as a space-scale localized alternative to the fourier transform is a favorite tool for fractal parameter estimation. The wavelet maxima representation (WMR) and recently the wavelet leaders representations, which keep only the relevant information from the CWT, have shown improved performance in the analysis of fractal signals. See S. Mallat, A Wavelet Tour of Signal Processing, 2nd ed. Academic Press, 1999; S. Jaffard, B. Lashennes, and P. Abry, “Wavelet leaders in multifractal analysis,” in Wavelet Analysis and Applications, T. Qian, M. I. Vai, and X. Yuesheng, Eds. Birkhauser Verlag, 2006, pp. 219-264.

Here we discuss a way to derive texture parameters of interest, from the wavelet maxima density values, estimated at different scales, in local regions of an image, such as an image of a skin lesion.

We illustrate the discriminative power of the WMR-based lacunarity parameters on images of skin cancer lesions. The WMR-based fractal descriptors are tested on data acquired using the MelaFind® instrument (see D. Gutkowicz-Krusin, M. Elbaum, M. Greenebaum, A. Jacobs, and A. Bogdan, “System and methods for the multispectral imaging and characterization of skin tissue,” 2001, U.S. Pat. No. 6,081,612), an automatic skin cancer diagnosis system of MELA Sciences, Inc.

Here we describe the use of local WMR density distributions to estimate lacunarity parameters and the use of new techniques to compare these distributions to generate lacunarity texture descriptors.

Because, in some implementations, in the WMR, we use only the positions of the maxima in the image plane, this representation has very low sensitivity to noise and to small variations in the imaging process, such as multiplicative gain, optical distortions, or magnification. There is no need for precise estimation of reflectance. The similarity and lacunarity parameters computed from the WMR density distributions thus are far more robust than when the intensity image representation is used.

The wavelet transform provides a signal representation that is localized in both space (time) and scale (frequency). The spatial localization property of wavelets is of interest in lacunarity analysis.

Most of the interesting information in a signal is determined by the changes in its values. As an example, in an image, we find the information by looking at the variation in pixel intensity. Wavelets measure signal variation locally at different scales.

The continuous wavelet transform (CWT) is a set of approximations (fine-scale to coarse-scale) obtained from an analysis (inner products) of an original signal f(x) with translated, scaled versions of a “mother wavelet” function ψ(x):

$$W {f}_{a τ} = f * ψ = \frac{1}{\sqrt{a}} \int f ( x ) ψ ( \frac{x - τ}{a} ) d x ,$$

where the wavelet representation Wf_{aτ}, off is indexed by position τ and the scale index (dilation) a. Admissibility conditions for the mother wavelet ψ(x) as required by the desired properties of Wf_{aτ}, have been well studied and understood. The CWT representation has the desired pattern recognition properties of translation and rotation invariance, but is extremely redundant and results in a data explosion. The wavelet maxima representation (WMR) was introduced by W. L. Hwang and S. Mallat. (Characterization of self-similar multifractals with wavelet maxima. Technical Report 641, Courant Institute of Mathematical Sciences, New York University, July 1993) to study the properties of transient signals. The WMR representation keeps only the position and amplitude of the local maxima of the modulus of the CWT. Local singularities (discontinuities) then can be characterized from the WMR decay as a function of scale. In image analysis, large signal variations usually correspond to edges, while small and medium variations are associated with texture. In two-dimensional signals, such as an image f(x,y), WMR is obtained from the one-dimensional CWT, applied to each of the image coordinates. Modulus and argument functions are created:

$$\begin{matrix}M {f}_{a} ( x , y ) = \sqrt{{\vert W {f}_{a}^{x} ( x , y ) \vert}^{2} + {\vert W {f}_{a}^{y} ( x , y ) \vert}^{2}} , & ( 1 ) \\ A f ( x , y ) = arctan ( W {f}_{a}^{y} ( x , y ) / {W}_{a}^{x} ( x , y ) ) & ( 2 )\end{matrix}$$

The local maxima of Mfₐ(x,y) (equation 1) are extracted using the phase information (equation 2).

Lacunarity, or translation inhomogeneity, is usually estimated from the raw image, thresholded using a meaningful algorithm to generate a binary image. Then a gliding box method is used to build a distribution for the point (pixel) count in the box as a function of box size. As an example (see A. J. Einstein, H.-S. Wu, and J. Gil, “Self-affinity and lacunarity of chromatin texture in benign and malignant breast epithelial cell nuclei,” Phys. Rev. Lett., vol. 80, no. 2, pp. 397-400, January 1998), gray images of cancerous cells are thresholded at the first quartile of the intensity histogram. A square box of side size R is moved pixel by pixel in the image region of interest. A probability distribution Q_{L,R}(N) having N points in a box of size R is generated this way. The ratio of a measure of dispersion over the center of the distribution is used in practice to compare two probability distributions. A widely used lacunarity estimate is the ratio of the second moment to the square of the first:

Λ_{L}(R)=N_{Q}⁽²⁾/(N_{Q}⁽¹⁾)², (3)

where N_{Q}⁽ⁱ⁾ is the i^{th} moment of Q(N). This estimate captures the change in Λ(R) as the box size R changes. The slope of the linear approximation of the lg(Λ(R)) vs lg(R) is the lacunarity measure. Q(N) is sensitive to the thresholding algorithm and artifacts in the raw image and as a result, it makes lacunarity unstable.

In image analysis, the texture descriptors, also known as features, are numerical measurements of a particular object inside a digital image and typically are used to quantize a property or for classification. For two-dimensional signals such as images, we estimate a set of lacunarity features for each wavelet level (scale) L, following these steps:

1. At each wavelet level (scale) L, we slide a box of size R over the region of interest and record the WMR counts in the box divided by the box size in pixels. For fixed L and R we generate a distribution of WMR densities Q_{L,R}(N), where N is the WMR density inside the gliding box.

2. We compute a lacunarity parameter Λ_{L}^{T}(R) which characterizes Q_{L,R}(N). Here T defines the parameter extracted from the WMR distributions, such as the mean, entropy, or the normalized dispersion defined in equation 3.

3. The lacunarity dimension is the slope of graph of the lacunarity parameter lg(Λ_{L}(R)) vs lg(R):

D_{L}(R)=lg(Λ_{L}^{T}(R))/lg(R) (4)

for a finite range of the gliding window sizes R C [R₁, R₂]. An example of the lacunarity plots and linear approximations for two observations (one positive and one negative) and the wavelet level L=2 are illustrated in FIG. 3, in which the window radius is from 5 to 14 pixels. The lacunarity dimensions D₂(R) are the slopes of the two regression lines.

We illustrate the generation of lacunarity texture features from observations in the MelaFind® pigmented lesion image database (see, e.g., Friedman et al, “The Diagnostic Performance of Expert Dermoscopists vs a Computer-Vision System on Small-Diameter Melanomas,” Arch. Dermatol. 2008; 144(4):476-482). Each observation is represented by 10 gray-intensity images obtained from imaging using narrow band colored light ranging from blue to infrared.

The lacunarity dimension type descriptors are the slope, intercept and the deviation from linearity of the linear interpolation of log(A_{L,R}) versus log(I_{L,R}) from the data.

The wavelet maxima representation for each individual image is computed using a mother wavelet which approximates the first derivative of a Gaussian (see S. Mallat, A Wavelet Tour of Signal Processing, 2nd ed. Academic Press, 1999), resulting in a dyadic (a=2^{L}, L=1, 2, . . . ) multiresolution representation. A sample image of the blue and infrared bands intensity and modulus maxima at level L=3, (see FIG. 1), are shown together with a map of the WMR positions (see FIG. 2, which is a zoom on (a subsection of) the WMR level 3, positions for the infrared image of FIG. 1. We look only at the WMR positions inside the lesion, as determined by a binary mask (not shown). Using the gliding box method we slide a circular window of radius R E {r, r+1, . . . , r+n} over the mask. The distribution of WMR counts Q_{L,R}(N) depends on the wavelet level L and the gliding window size R. We generate more than 5000 features from the wavelet maxima probability densities Q_{L,R}(N) of each image. Because the plots in FIG. 3 exhibit nonlinear behavior, we generate the lacunarity dimension texture descriptors on bounded regions for R such as from 5 to 9 pixels.

We test the lacunarity texture descriptors for their discrimination power on the test data. The figure of merit we use for each feature is the separability between the two classes and is the area under ROC (receiver operating characteristic) generated by the numerical values of that feature. We then plot the scores in decreasing order for each group on the same graph.

In FIG. 4, we compare the performance of the lacunarity features grouped by the parameter Λ_{L}^{T}(R) used to characterize the family of distributions Q_{L,R}(N) inside the gliding box. The figure of merit is area under ROC.

In FIG. 5, we compare the lacunarity features when Λ_{L}^{T}(R) is computed with the entropy or the mean/std of Q_{L,R}(N). Because all the other parameters of the features are the same, we can match the feature indexes one to one. The graph is ordered using the entropy-based features. Entropy is a measure of the randomness of the wavelet maxima distribution and thus is more informative than other descriptors such as the ratio of mean to standard deviation, which characterizes only the width of the distribution. We see (from the graph) that entropy is doing the better job of extracting information from the Q_{L,R}(N).

We use the lacunarity texture descriptors defined in the previous sections to train a support vector machines (SVM) classifier. To reduce the number of available features to approximately 100, we use the random forests capability to rate variables. Random forest is a classifier that consists of many decision trees but is also used to evaluate feature importance using the Gini and the out-of-bag (OOB) error estimates. The final classifier is built with 39 features, down from the initial pool of 100. We use a forward feature selection method to train the SVM classifier. The classification score is the area under ROC for each test classifier.

In applications such as cancer detection it is usual to have asymmetric data, in our case a 5 to 1 ratio of positive to negative observations. The misclassification cost is also asymmetric, the cost of missing a melanoma being much higher than missing a benign lesion. A cost function based on the area under ROC used in training the classifier aims to achieve sensitivity Sₑ=100% (sensitivity being the percentage of correct classified positive observations) and maximize the number of correctly classified negative observations. The SVM classifier achieves the performance described in Table I. This is a good result for this type of data and application and considering that only lacunarity based features are used in the classifier.

TABLE 1
SVM classifier with RBF kernel. 40 features, tested on the
training and blind test sets.

| | Training Set | Test Set |
|---|---|---|
| Sensitivity | 100% | 100% |
| Specificity | 22% | 22.7% |
| Area under ROC | .903 | .832 |

Important aspects of the techniques described here are the use of WMR density as the measure on which the fractal descriptors are built and the computation of the parameter Λ_{L}^{T}(R) from the distribution of the WMR densities Q_{L,R}(N) with new methods. When Λ_{L}^{T}(R) is based on entropy as opposed to the traditional mean/standard deviation, we obtain a much better separability on our test data.

The techniques described here can be implemented in a variety of ways using hardware, software, firmware, or a combination of them to process image data and produce intermediate results about lacunarity, texture, and other features. The techniques can also be used as part of a wide variety of medical and other non-medical devices used to acquire, process, and analyze images.

Other implementations are also within the scope of the following claims.

What is claimed is:

1. A computer-implemented method comprising:
characterizing a texture of an image by deriving entropy-based lacunarity parameters from density distributions generated from the image based on a wavelet analysis.

2. The method of claim 1 in which the entropy-based lacunarity parameters are derived from information theory entropy of wavelet maxima density distributions.

3. The method of claim 1 comprising generating one or more texture features for the image from the density distributions using the entropy-based lacunarity parameters.

4. The method of claim 1 in which the image comprises a multispectral image.

5. The method of claim 1 in which the image comprises an image of a biological tissue.

6. The method of claim 1 in which the wavelet analysis is based on a wavelet maxima representation of a gray scale image.

7. The method of claim 1 in which the image comprises an analysis region having a skin lesion.

8. The method of claim 1 in which the entropy-based lacunarity parameters are estimated at various scales.

9. The method of claim 1 in which the entropy-based lacunarity parameters are estimated in local regions of the image.

10. The method of claim 1 in which the density distributions are derived at least in part based on a gliding box method.

11. The method of claim 10 in which the gliding box method uses a window of fixed characterizing size R.

12. The method of claim 11 in which the window comprises a circular window.

13. The method of claim 11 in which wavelet maxima in the window are counted to generate a distribution of the counts indexed by a wavelet level L.
